(19) United States
(12) Patent Application Publication
(10) Pub. No.: US 2015/0356310 A1
(43) Pub. Date: Dec. 10, 2015

(54) APPLICATION SOFTWARE SERVICE SYSTEM FOR CONTROLLING UI ACCESS ACCORDING TO USER LEVEL AND METHOD THEREOF

(71) Applicant: ELECTRONICS AND TELECOMMUNICATIONS RESEARCH INSTITUTE, Daejeon (KR)

(72) Inventors: Won Young KIM, Daejeon (KR); Won Hyuk CHOI, Daejeon (KR); Su Min JANG, Daejeon (KR); Moon Young CHUNG, Daejeon (KR); Kyung Ah YANG, Daejeon (KR)

(21) Appl. No.: 14/736,113

(22) Filed: Jun. 10, 2015

(30) Foreign Application Priority Data
Jun. 10, 2014 (KR) 10-2014-0070170

(51) Int. Cl. G06F 21/62; H04L 29/06

(52) U.S. Cl. CPC G06F 21/629; H04L 67/42; H04L 63/102

(57) ABSTRACT

Disclosed is a technology for controlling UI access to application software according to user's levels. The method for controlling UI access according to users' levels is characterized in providing a user with differentiated UI information according to user levels based on user-level-specific UI data in which UI information about functions to which access is allowed among functions provided by the application software is defined according to types of users.

### CROSS-REFERENCE TO RELATED APPLICATION

This application claims priority to and the benefit of Korean Patent Application No. 10-2014-0070170, filed on Jun. 10, 2014, the disclosure of which is incorporated herein by reference in its entirety.

### BACKGROUND

1. Field of the Invention

The present invention relates to an application software service, and in particular, to a technology for controlling a user interface (UI) of the application software to which access is allowed according to a user level.

2. Discussion of Related Art

With the advent of the cloud computing age, a method of borrowing resources (application software) as needed is gaining favor over the existing method of using resources by purchasing, installing and managing them. Such resource borrowing may be applied directly to package-based application software. If application software is used through the resource borrowing service, private users may be freed from tedious processes such as installation, update and backup of applications, and companies and organizations may identify the demand for application software needed by their members so that an appropriate amount of application software can be purchased. In addition, developers and service providers of application software may identify the actual status of application software use and receive reasonable payments.

Meanwhile, even when the same application software is used, the levels of functions used may vary according to types of users. For example, an architect uses all the functions provided by building-design software in order to design a building, whereas customers use only simple functions to view design drawings at various angles or change colors of designed products. Accordingly, there is no need to provide every user with all of the functions of application software.

However, it is also difficult to develop and distribute application software whose UIs are slightly different for different types of users. These types of demands have been responded to in some application software such as Office. To meet the needs of users, the application software has provided viewers that can display written documents.

However, viewers provide only limited functions when compared with the original application software, and thus fail to suit various types of users.

### SUMMARY OF THE INVENTION

The present invention is directed to an application software service for differentially controlling UI access of application software according to user levels.

In accordance with an aspect of the present invention, a method for providing user interface (UI) access control with respect to application software in a system including a server and a client according to user levels, the method includes: providing a user with differentiated UI information according to different user levels.

The system may operate in a graphic offloading computing environment in which application software is run in the server and rending is performed in the client.

The providing of the user with differentiated UI information according to user levels comprises: the client receiving a rendering command filtered by the server based on user-level-specific UI data in which UI information about functions to which access is allowed among functions provided by the application software is defined according to types of users.

The providing of the user with differentiated UI information according to user levels comprises: providing UI information about a function to which access is allowed at a user level among the functions provided by the application software in a differentiated manner based on user-level-specific UI data in which UI information about functions to which access is allowed among the functions provided by the application software is defined according to types of users.

The user-level-specific UI data is constructed in database, and managed by the server.

The providing of the user with differentiated UI information according to user levels comprises: the client receiving user-level-specific UI data in which UI information about functions to which access is allowed among functions provided by the application software is defined according to types of users, from the server; and the client filtering to determine whether a function selected by the user among the functions is a function to which access is allowed at the user's level based on types of users defined in the user-level-specific UI information.

The performing of filtering comprises: the client transferring an execution request for a function to which access is determined to be allowed at the user's level to the server.

The performing of filtering comprises: the client providing a message indicating unavailability of a function to which access is determined not to be allowed at the user's level.

The providing of the user with differentiated UI information according to user levels comprises: the client receiving an execution scene of the application software filtered by the server based on user-level-specific UI data in which UI information about functions to which access is allowed among functions provided by the application software is defined according to types of users.

The providing of the user with differentiated UI information according to user levels comprises: the server hooking an input command to perform a function execution, the input command transmitted from the client; and the server performing filtering to determine whether the input command is a command to which access is allowed at a user's level based on user-level-specific UI data in which UI information about functions to which access is allowed among functions provided by the application software is defined according to types of users.

The performing of filtering further comprising: the server transmitting a rendering scene rendered by executing the input command to which access is determined to be allowed at the user's level to the client.

The providing of the user with differentiated UI information according to user levels comprises: providing an operation scene in which a function which is not allowed to be provided to a user based on user-level-specific UI data in which UI information about functions to which access is allowed among functions provided by the application software is defined according to types of users is inactivated.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a method for constructing a user-level-specific UI database for an application software service in which UI access can be controlled according to user levels in accordance with the present invention;

FIG. 2 is a block diagram illustrating a system for providing UI access control with respect to application software in accordance with an exemplary embodiment of the present invention;

FIG. 3 is a block diagram illustrating a system for providing UI access control with respect to application software in accordance with another exemplary embodiment of the present invention;

FIG. 4A is a flowchart showing a method for providing UI access control according to user levels in an application software service system in accordance with an exemplary embodiment of the present invention;

FIG. 4B is a flowchart showing a method for providing UI access control according to user levels in a server, and FIG. 4C is a flowchart showing a method for providing UI access control according to user levels in a client;

FIG. 5 is a flowchart showing a method for providing UI access control according to user levels in an application software service system in accordance with another exemplary embodiment of the present invention; and

FIG. 6 is a block diagram illustrating a computer system for the present invention.

### DETAILED DESCRIPTION OF EXEMPLARY EMBODIMENTS

The advantages and features of the present invention, and methods of accomplishing the same, will become readily apparent with reference to the following detailed description and the accompanying drawings. However, the scope of the present invention is not limited to embodiments disclosed herein, and the present invention may be realized in various forms. The embodiments to be described below are provided merely to fully disclose the present invention and assist those skilled in the art in thoroughly understanding the present invention. The present invention is defined only by the scope of the appended claims. Meanwhile, the terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Hereinafter, exemplary embodiments of the present invention will be described in detail with reference to the accompanying drawings. The same reference numerals are used to designate the same elements throughout the drawings Descriptions of well-known functions and structures are omitted to enhance clarity and conciseness.

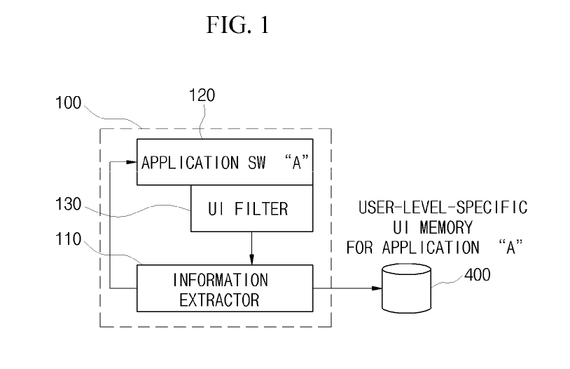

In order to control UI access according to user levels with respect to certain application software, user-level-specific UI information needs to be defined before a service is performed. In this regard, an apparatus as shown in FIG. 1 is required, and the apparatus may be provided using a computing terminal 100.

An administrator, for example, an application software developer or an application software provider, defines user-level-specific UIs (functions) for application software using the computing terminal 100 in advance. For example, the user-level-specific UI may be divided into a full version, a simple manipulation and easy editing version, a simple manipulation version and a viewer version according to user levels (for example, a power user, a user, a simple user and a visitor). Various versions may be divided for different user levels according to an administrator's predetermined setting.

In detail, in order to extract user-level-specific UI information, an administrator may execute an information extractor 110 of the computing terminal 100 and run application software 120 to be serviced. When a function or a menu to which access is allowed at a certain user level is executed, the information extractor 110 may extract internal UI data about the function and menu through a UI filter 130 that is executed in addition to the application software 120.

In order to identify a function that is to be performed by a command corresponding to the function selected by the user, various data is required. Firstly, a UI title may be used. Secondly, a class name of a UI, a window name or a UI template may be used, and information about location on a UI may be used. Lastly, a different function may be performed depending on an upper level window, even if the UI title is the same.

Through such a process, with respect to certain application software, a desired number of user levels and UI information about functions and menus to which access at each user level is allowed may be generated as user-level-specific UI data. In addition, user-level-specific data about individual application software may be stored in an additional database 400 (a user-level-specific UI database). That is, the user-level-specific UI data may be defined as UI information about functions to which access by a type of user (or at a user level) is allowed among functions provided by application software according to user types (or user levels).

Thereafter, a client 210 and 310 and a server 220 and 320 in an application software service system according to the present invention may control UI access according to a user level by using the user-level-specific UI data about application software obtained from the database 400.

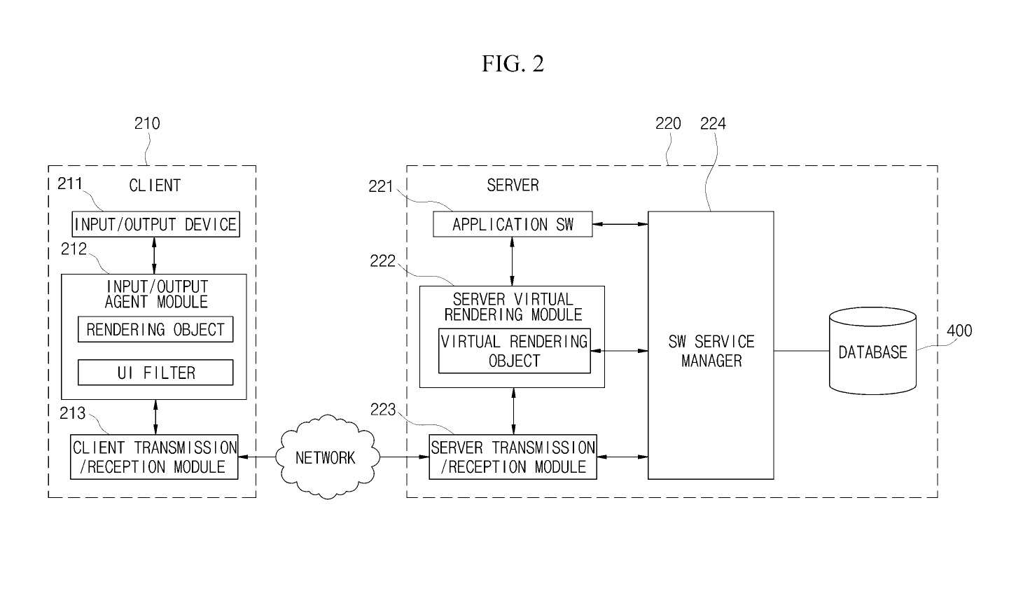

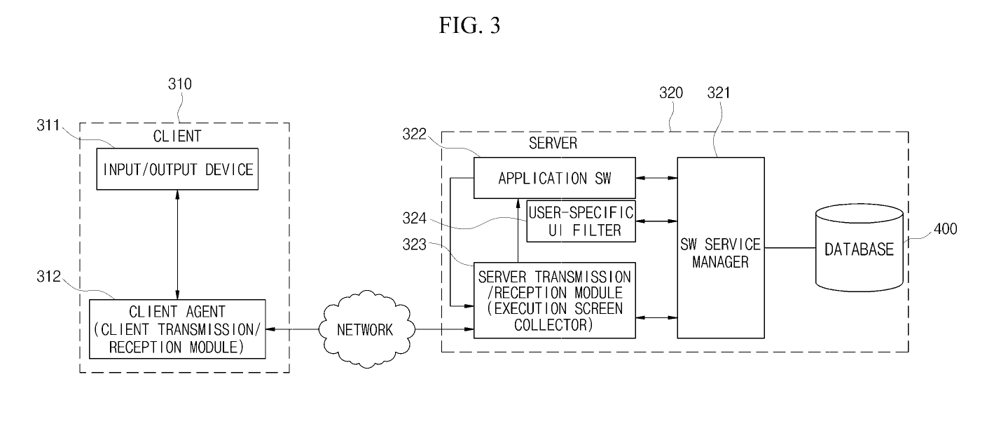

Hereafter, an application software service system for controlling UI access according to user levels with respect to application software will be described in detail with reference to FIGS. 2 and 3.

FIG. 2 is a block diagram illustrating a system for providing UI access control with respect to application software in accordance with an exemplary embodiment of the present invention.

FIG. 2 illustrates an application software service system for providing UI access control according to user levels in a graphic offloading computing environment in which package-based application software (application SW) is run by a server 220 and rendering is performed by a client 210.

Referring to FIG. 2, the application software service system for providing UI access control according to user levels in accordance with an exemplary embodiment of the present invention includes the client 210 and the server 220.

The client 210 requests an application software service from the server 220 according to a user's input. In addition, when a request for providing a service of certain application software is input by a user through an input/output device 211 of the client 210, the client 210 requests the application software service from the server 220 through a client transmission/reception module 213. The input/output device 211 may be provided using a mouse or a keyboard, and a user may request a service of desired application software through a mouse click or a keyboard input.

The request for the application software service input by the client 210 is transmitted to the server 220 through a network. In this case, the transmission/reception module 213 of the client 210 and a transmission/reception module 223 of the server 220 support a network connection.

An SW service manager 224 of the server 220 runs corresponding application software 221 in response to the request for application software service.

A server virtual rendering module 222 of the server 220 hooks a rendering command among commands generated during execution of the application software, and transmits the rendering command to the client 210 through the server transmission/reception module 223 such that rendering is performed on the corresponding UI in the client 210. At the same time, a virtual rendering object corresponding to an actual rendering object is managed in the server 220 so as to be processed as if rendering is virtually performed in the server.

When the application software is run for the first time, the SW service manager 224 of the server 220 acquires user-level-specific UI data from a database (the user-level-specific UI database) 400, and transmits the user-level-specific UI data to the client 210.

An input/output agent module 212 of the client 210 executes a command of the application software received from the server 220 through the client transmission/reception module 213 (a rendering command), and internally manages rendering objects. In the rendering, a function to which a user is not allowed access according to the user-level-specific UI data is represented in an inactivated state such that the user's access is prevented.

If a user selects a desired function among functions provided by application software through the input/output device 211, and requests execution of the function, the input/output agent module 212 performs filtering to determine using a UI filter whether access to the selected function is allowed at the user's level. For example, a user may select a function that he or she desires to perform among functions provided by application software through a mouse click or a keyboard input. In this case, a UI filter of the input/output agent module 212 determines whether access to the function selected by the user is allowed at the user's level by using the user-level-specific UI data received from the server 220.

According to a result of the filtering through the UI filter, if the function selected by the user is a function to which access is allowed at the user's level, the input/output agent module 212 of the client 210 transmits an execution request for the function to the server 220 such that the function is executed. That is, the server 220 receives an execution request for a function determined through filtering (determined) by the client 210 as a function to which access is allowed at the user's level. The server 220 executes the requested function, and transmits a result of the execution (UI and rendering command with respect to the executed function) to the client 210. In this manner, the user may use the function of the application software to which access is allowed at the user's level through the client 210.

Meanwhile, a function selected by the user may be a function to which access may be not allowed at the user's level. In this case, the UI filter of the input/output agent module 212 may provide (output) a message indicating unavailability of the function (a function for which it is determined that access is not allowed at the user's level) to the user. That is, the client 210 does not transmit an execution request for a function that is not allowed (an unallowable function) to the server 220, and outputs a message indicating unavailability with respect to the function, to which access is not allowed, through the input/output device 211, thereby notifying the user that the function is unavailable.

Therefore, when the application software service according to the present invention is provided, functions provided by the package-based application software may be differentially provided according to user levels without changing the application software.

FIG. 3 is a block diagram illustrating a system for providing UI access control with respect to application software in accordance with another exemplary embodiment of the present invention.

FIG. 3 illustrates an application software service system for providing UI access control according to user levels in a service environment in which package-based application software (application SW) is run and graphic rendering is performed in a server 320.

Referring to FIG. 3, the application software service system for providing UI access control according to user levels in accordance with an exemplary embodiment of the present invention includes a client 310 and a server 320.

A user inputs a request for a service of certain application software through an input/output device 311 of the client 31, and the client 310 requests the service of application software from the server 320 through a client agent 312 (a client transmission/reception module).

Upon receiving the request for the service of the application software from the client 310 through a server transmission/reception module 323, an SW service manager 321 of the server 320 runs corresponding application software 322 in response to the request.

User-level-specific UI data, in which UI information about functions to which access is allowed at user levels (for types of users) is defined, is transmitted to a user-specific UI filter 324 attached to an application software process. In this case, the user-level-specific UI data may be obtained from an additional user-level-specific UI database 400, and may be transmitted to the user-specific UI filter 324.

Meanwhile, an execution scene rendered by executing the application software is collected and compressed by an execution scene collector of the server transmission/reception module 323, and is transmitted to the client 310. The client agent 312 of the client 310 restores the execution scene that is sent in a compressed form, and outputs the restored execution scene to a user through the input/output device 311.

For example, it may be assumed that a user selects a certain function that he or she desires to use among functions provided by application software. That is, when the user selects a certain function through the input/output device 311 of the client 310 among functions provided by application software, the client 310 transmits the user's selection input to the server 320 through the client transmission/reception module of the client agent 312. The selection input may be a position value (X, Y coordinate values) on a window input through a mouse.

The selection input transmitted from the client 310 is transferred to the application software 322 through the server transmission/reception module 323, and is mapped with a function at a corresponding position of an application screen. The mapped function is hooked by the user-specific UI filter 324 that is configured to hook all commands (execution commands for functions) transmitted to the application software 322.

The user-specific UI filter 324 performs filtering to determine whether a function selected by a user among functions provided by application software (that is, a function corresponding to a hooked execution command) is a function to which access is allowed at the user's level. That is, the user-specific UI filter 324 recognizes the user's level, and determines whether to execute a function corresponding to the hooked execution command.

For example, it may be assumed that the user-specific UI filter 324 determines that access to a function selected by a user is allowed at the user's level. In this case, the SW service manager 321 of the server 320 performs an operation for the function (the function to which access is allowed). An execution scene of the application software according to execution of the function is also transmitted to the client 310 through the server transmission/reception module 323, and to the user.

If it is determined from the filtering that access to the function selected by the user is not allowed at the user's level, the SW service manager 321 of the server 320 returns a message indicating unavailability to the client 310 through the server transmission/reception module 323.

The message indicating unavailability received from the server 320 is output through the input/output device 311 of the client 310, so that the user is notified that access to the function selected by the user is not allowed and the function is thus unavailable.

As described above, when the application software service is provided, functions provided by the package-based application software are differentially provided according to user levels without changing the application software.

That is, as shown in FIGS. 2 and 3, providing the application software in various versions leads to more convenient development and management of application software and provides users with various systems for providing functions and for charging, thus providing SW developers, SW service providers and SW users with convenience and variety of use.

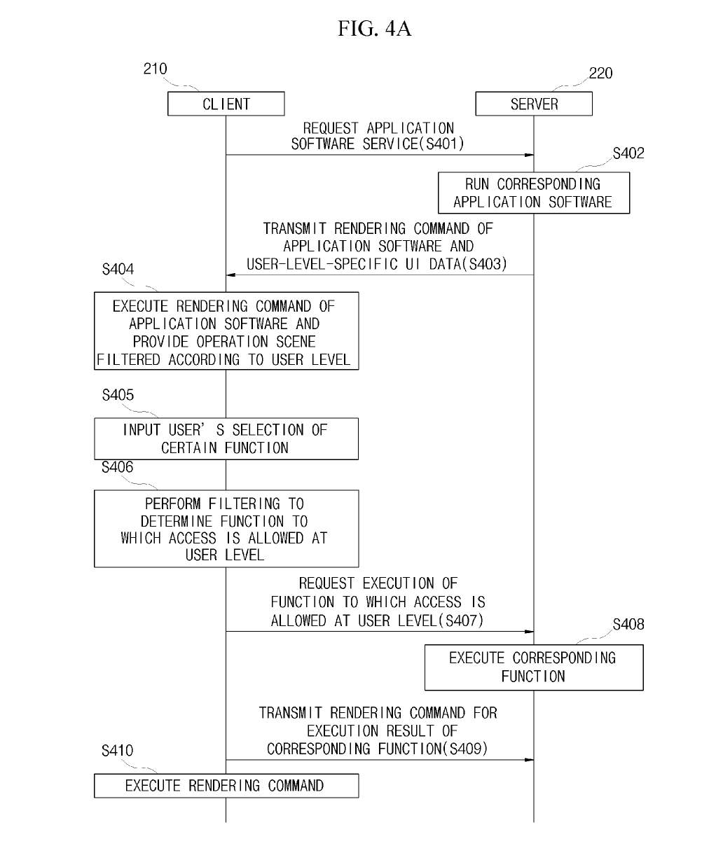

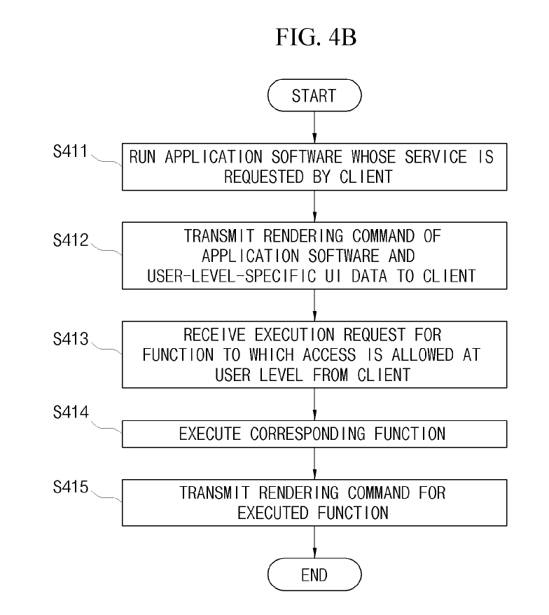

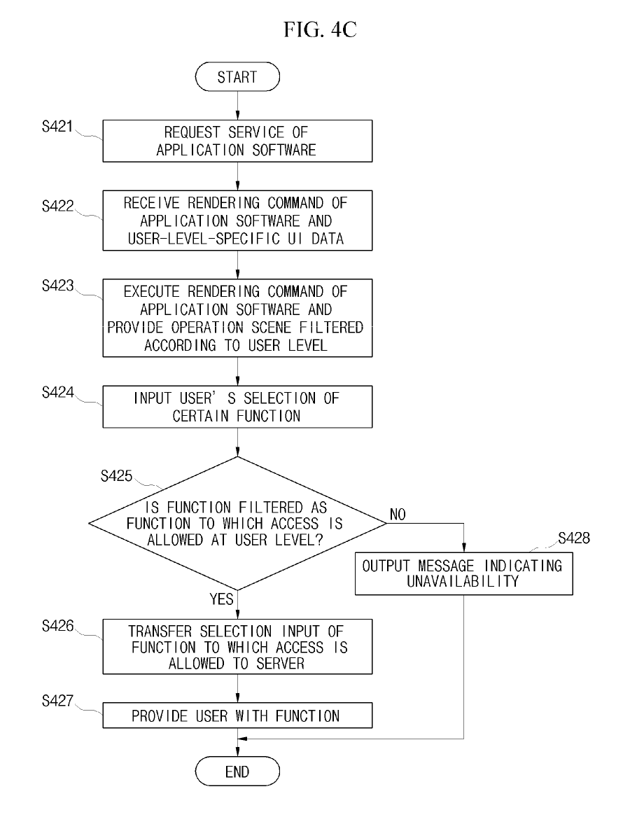

FIG. 4A is a flowchart showing a method for providing UI access control according to user levels in an application software service system in accordance with an exemplary embodiment of the present invention. The application software service system provides UI access control according to user levels in a graphic offloading computing environment in which package-based application software is executed by the server 220 and rendering is performed by the client 210.

First, the client 210 requests an application software service from the server 220 according to a user's input (S401). In detail, upon receiving a request for a service of certain application software desired by a user through a user's mouse click or keyboard input, the client 210 requests the service of the application software from the server 220.

The server 220 runs the corresponding application software 221 in response to the request for the service of the application software transmitted from the client 210 (S402). In addition, the server 220 transmits a rendering command of the application software and user-level-specific UI data to the client 210 such that actual rendering is performed in the client 210 (S403). In detail, the server 220 acquires user-level-specific UI data about a user who has requested the service from the database 400, and transmits the acquired user-level-specific UI data to the client 210.

The client 210 executes the command of the application software transmitted from the server 220 (the rendering command), and outputs an operation scene generated by the execution (S404). In this case, the operation scene is provided such that a function which is not allowed to be provided to a user based on the user-level-specific UI data is inactivated. That is, at the rendering, a function to which a user is not allowed access according to the user-level-specific UI data is represented in an inactivated state such that user's access is prevented.

The user may select one or more functions among functions provided by application software, and execution (S405) of the function selected by the user is filtered by the client 210 prior to being transferred to the server (S406). In detail, the client 210 may determine whether access to a function selected by a user is allowed at the user's level using the user-level-specific UI data transmitted in operation S403.

According to a result of the filtering in operation S406, the client 210 transmits an execution request for a function to which access is allowed at the user's level to the server 220 (S407). The server 220 executes the function for which the request has been transmitted from the client 210 (S408).

Thereafter, a rendering command for the execution performed in the server 220 is transmitted to the client 210 (S409), and the client 210 executes the received rendering command (S410). Accordingly, the user may use only the function of the application software to which the user is allowed access (a function to which access is allowed among functions the user has requested to execute) through the client 210.

Although not shown in FIG. 4A, operations S405 to S410 may be repeatedly performed for each function selected by the user.

Hereinafter, a method of providing UI access control according to user levels in the server 220 and the client 210 will be described in detail with reference to FIGS. 4B and 4C.

FIG. 4B is a flowchart showing a method for providing UI access control according to user levels in the server of FIG. 4A.

Referring to FIG. 4B, the server 220, upon receiving a request for a service of application software from the client 210, runs the corresponding application software in response to the request (S411).

Thereafter, the server 220 transmits a rendering command of the application software and a user-level-specific UI data to the client 210 such that actual rendering for the application software is performed by the client 210 (S412). In detail, the server 220 acquires user-level-specific UI data about a user who has requested the service from the database 400, and transmits the acquired user-level-specific UI data to the client 210.

Thereafter, upon receiving a request for executing a function to which access is allowed at a user level from the client 210 (S413), the server 220 executes the function (S414). The function for which execution is requested is a function determined through filtering by the client 210 as a function to which access is allowed at the user's level among functions provided by the application software using the user-level-specific UI data.

The server 220 transmits a rendering command for the function for which execution is requested to the client 210 (S415), and the user can use the function of the application software to which the user is allowed access through the client 210.

Although not shown in FIG. 4B, operations S413 to S415 may be repeatedly performed for a function selected by the user.

FIG. 4C is a flowchart showing a method for providing UI access control according to user levels in a client.

Referring to FIG. 4C, the client 210 requests a service of application software from the server 220 according to a user's input (S421). In detail, upon receiving a request for a service of certain application software that a user desires to execute through a mouse click or a keyboard input, the client 210 requests a service of the application from the server 220.

Thereafter, the client 210 receives a rendering command of the application software and user-level-specific UI data from the server 220 (S422).

Thereafter, the client 210 executes the rendering command of the application software, and outputs an operation scene that is filtered according to user levels (S423). In this case, a function which is not allowed to be provided to a user according to the user-level-specific UI data is provided in an inactivated state. That is, in the rendering, a function to which a user is not allowed access according to the user-level-specific UI data is represented in an inactivated state such that user's access is prevented.

A user may select one or more functions from among functions provided by the application software, and execution (S424) of the function selected by the user may be filtered by the client 210 prior to being transferred to the server (S425). In detail, the client 210 determines whether the function selected by the user is a function to which access is allowed at the user's level using the user-level-specific UI data received in operation S422.

If it is determined according to the filtering in operation S425 that the function selected by the user is a function to which access is allowed at the user's level, the client 210 transmits an execution request for the function (the function to which access is allowed) to the server 220 (S426).

Thereafter, a rendering command for a result executed in the server 220 is transmitted to the client 210, and the client 210 executes the received rendering command. Accordingly, the user may use only the function of the application software to which the user is allowed access through the client 210 (a function to which access is allowed among functions requested by the user) (S427).

If it is determined according to the filtering in operation S425 that the function selected by the user is a function to which access is not allowed at the user's level, the client 210 outputs a message indicating unavailability of the function (the function to which access is not allowed) (S428). That is, the client 210 does not transmit a selection input for the function which is not allowed (the unallowable function) to the server 220, and outputs a message indicating unavailability of the unallowable function through the input/output device 211, thereby notifying the user that access to the function selected by the user is not allowed and the function is thus unavailable.

Therefore, when the application software service is provided according to the present invention, functions provided by the package-based application software may be differentially provided according to the user levels without changing the application software.

Although not shown in FIG. 4C, operations S424 to S427 may be repeatedly performed for each function selected by the user.

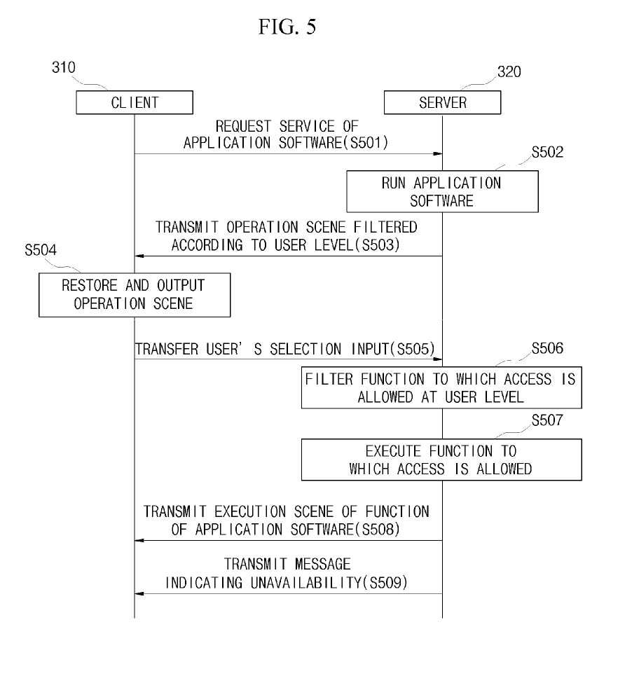

FIG. 5 is a flowchart showing a method for providing UI access control according to user levels in an application software service system in accordance with another exemplary embodiment of the present invention. The application software service system provides UI access control according to user levels in a service environment in which package-based application software is run by the server 320 and graphic rendering is performed by the server 320.

First, the client 310 requests an application software service from the server 320 according to a user's input (S501). In detail, upon receiving a request for a service of certain application software desired by a user through a user's mouse click or keyboard input, the client 310 requests the service of the application software from the server 320.

The server 320, upon receiving the request for the application software service from the client 310, runs the corresponding application software 322 in response to the request (S502). In this case, user-level-specific UI data in which UI information about functions to which access is allowed among functions provided by the application software is defined according to levels (types) of users is transmitted to a user-specific UI filter 324 attached to the application software process UI. The user-level-specific UI data may be obtained from an additional user-level-specific UI database 400, and may be transmitted to the user-specific UI filter 324.

Meanwhile, the server 320 renders an operation scene of the application software that is filtered according to a level of the user who has requested the service by using the user-level-specific UI data, and transmits the operation scene to the client 310 (S503).

The client 310 outputs the operation scene transmitted from the server 320 to the user (S504).

Thereafter, the client 310 transmits a function selected by a user among functions provided by the application software to the server 320 (S505). For example, when a user desires to use a certain function among functions provided by the application software and selects the function, which may be one or more functions, the client 310 transmits the user's selection input to the server 320.

The server 320 performs filtering to determine whether the function selected by the user is a function to which access is allowed at the user's level (S506). In this case, the selection input of the function is hooked by the user-specific UI filter 324 that is configured to hook all commands (execution commands for functions) transmitted to the application software 322.

The user-specific UI filter 324 performs filtering to determine whether the function selected by the user among functions provided by the application software (that is, a function corresponding to the hooked execution command) is a function to which access is allowed at the user's level. That is, the user-specific UI filter 324 recognizes the user's level and determines whether to execute the hooked function.

When it is assumed that it is determined through the filtering that the function selected by the user is a function to which access is allowed, the server 320 performs an operation corresponding to the function (the function to which access is allowed) (S507). Thereafter, an execution scene of the application software according to the execution of the function is transmitted to the client 310 (S508).

If it is determined through the filtering that the function selected by the user is a function to which access is not allowed at the user's level, the server 320 returns a message indicating unavailability of the function to the client 310 (S509).

The message indicating unavailability received from the server 320 is output through the input/output device 311 of the client 310, thereby notifying the user that access to the function selected by the user is not allowed and the function is thus unavailable.

Therefore, when the application software service is provided according to the present invention, functions provided by package-based application software may be differentially provided according to the user levels without changing the application software.

Although not shown in FIG. 5, operations S505 to S509 may be repeatedly performed for each function selected by the user.

As is apparent from the above, the application software service can provide functions of package-based application software to be differentiated according to user levels, without having to change the application software.

Because the same application software is provided in various versions, development and management of the application software are more convenient, and users can use various systems for providing functions and for charging, thereby SW providing developers, SW service provider and SW users with convenience and variety of use.

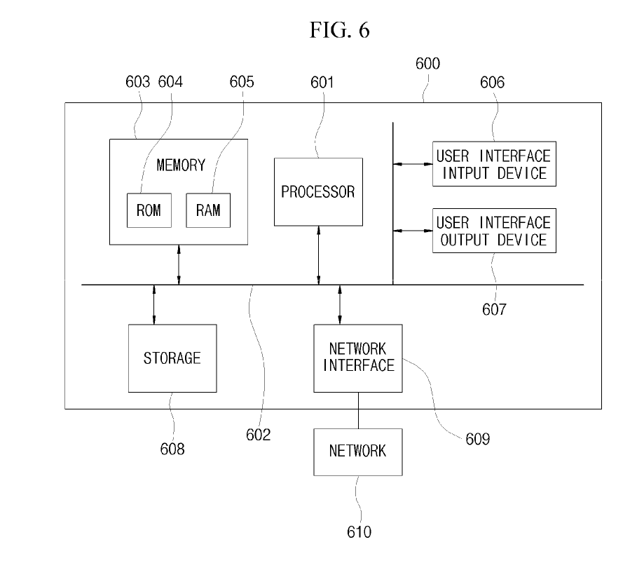

An embodiment of the present invention may be implemented in a computer system, e.g., as a computer readable medium. As shown in FIG. 6, a computer system 600 may include one or more of a processor 601, a memory 603, a user input device 606, a user output device 607, and a storage 608, which communicate with one another through a bus 602. The computer system 600 may also include a network interface 609 that is coupled to a network 610. The processor 601 may be a central processing unit (CPU) or a semiconductor device that executes processing instructions stored in the memory 603 and/or the storage 608. The memory 603 and the storage 608 may include various forms of volatile or non-volatile storage media. For example, the memory may include a read-only memory (ROM) 604 and a random access memory (RAM) 605.

It will be apparent to those skilled in the art that various modifications can be made to the above-described exemplary embodiments of the present invention without departing from the spirit or scope of the invention. Thus, it is intended that the present invention cover all such modifications provided they come within the scope of the appended claims and their equivalents.

What is claimed is:

1. A method for providing user interface (UI) access control with respect to application software in a system including a server and a client according to user levels, the method comprising: providing a user with differentiated UI information according to user levels.

2. The method of claim 1, wherein the system operates in a graphic offloading computing environment in which application software is run in the server and rending is performed in the client.

3. The method of claim 2, wherein the providing of the user with differentiated UI information according to user levels comprises: the client receiving a rendering command filtered by the server based on user-level-specific UI data in which UI information about functions to which access is allowed among functions provided by the application software is defined according to types of users.

4. The method of claim 1, wherein the providing of the user with differentiated UI information according to user levels comprises: providing UI information about a function to which access is allowed at a user level among the functions provided by the application software in a differentiated manner based on user-level-specific UI data in which UI information about functions to which access is allowed among the functions provided by the application software is defined according to types of users.

5. The method of claim 4, wherein the user-level-specific UI data is constructed in database, and managed by the server.

6. The method of claim 1, wherein the providing of the user with differentiated UI information according to user levels comprises:
the client receiving user-level-specific UI data in which UI information about functions to which access is allowed among functions provided by the application software is defined according to types of users, from the server; and
the client filtering to determine whether a function selected by the user among the functions is a function to which access is allowed at the user's level based on types of users defined in the user-level-specific UI information.

7. The method of claim 6, wherein the performing of filtering comprises: the client transferring an execution request for a function to which access is determined to be allowed at the user's level to the server.

8. The method of claim 6, wherein the performing of filtering comprises: the client providing a message indicating unavailability of a function to which access is determined not to be allowed at the user's level.

9. The method of claim 1, wherein the providing of the user with differentiated UI information according to user levels comprises: the client receiving an execution scene of the application software filtered by the server based on user-level-specific UI data in which UI information about functions to which access is allowed among functions provided by the application software is defined according to types of users.

10. The method of claim 1, wherein the providing of the user with differentiated UI information according to user levels comprises:
the server hooking an input command to perform a function execution, the input command transmitted from the client; and
the server performing filtering to determine whether the input command is a command to which access is allowed at a user's level based on user-level-specific UI data in which UI information about functions to which access is allowed among functions provided by the application software is defined according to types of users.

11. The method of claim 10, wherein the performing of filtering further comprising: the server transmitting a rendering scene rendered by executing the input command to which access is determined to be allowed at the user's level to the client.

12. The method of claim 1, wherein the providing of the user with differentiated UI information according to user levels comprises:
providing an operation scene in which a function which is not allowed to be provided to a user based on user-level-specific UI data in which UI information about functions to which access is allowed among functions provided by the application software is defined according to types of users is inactivated.
